(19) United States
(12) Patent Application Publication
(10) Pub. No.: US 2018/0014166 A1
(43) Pub. Date: Jan. 11, 2018

(54) Push-To-Talk Devices with Auxiliary Audio

(71) Applicant: Black Diamond Advanced Technology, LLC., Chandler, AZ (US)

(72) Inventors: Verne Patterson, Lacey, WA (US); Lee Studley, Phoenix, AZ (US); Justin Dyster, Queen Creek, AZ (US); Colin Oetken, Gilbert, AZ (US)

(21) Appl. No.: 15/642,560

(22) Filed: Jul. 6, 2017

Related U.S. Application Data
(60) Provisional application No. 62/358,703, filed on Jul. 6, 2016.

(51) Int. Cl. H04W 4/10; H04M 1/60

(52) U.S. Cl. CPC H04W 4/10; H04M 1/6066; H04B 1/385; H04B 2001/3866

(57) ABSTRACT

Communications systems containing a Push-To-Talk (PTT) device containing an auxiliary audio component are described in this application. The communication system can be worn by an operator and comprises a radio, a headset, a communication device (such as a cellular phone), and a Push-To-Talk (PTT) device modified with an auxiliary audio component capable of overriding or controlling communication between the headset and the communication device when a signal is transmitted to or received from the radio. The modified PTT device allows the operator of the system when wearing the headset to use the communication device (i.e., cellular phone) without the fear of interrupting communication with the radio. Other embodiments are described.

### FIELD

This application relates generally to communication devices and systems. More specifically, this application relates to communications systems comprising a Push-To-Talk (PTT) device containing an auxiliary audio component.

### BACKGROUND

Radio transmission and reception is the technology of using radio waves to carry information, such as sound, by systematically modulating properties of electromagnetic energy waves transmitted through space, such as their amplitude, frequency, phase, or pulse width. When radio waves strike an electrical conductor, the oscillating fields induce an alternating current in the conductor. The information in the waves can be extracted and transformed back into its original form.

Radio systems need a transmitter to modulate (change) some property of the energy produced to impress a signal on it, for example using amplitude modulation or angle modulation (which can be frequency modulation or phase modulation). Radio systems also need an antenna to convert electric currents into radio waves, and vice versa. An antenna can be used for both transmitting and receiving. The electrical resonance of tuned circuits in radios allows individual stations to be selected or certain frequencies (channels) to be monitored. The electromagnetic wave is intercepted by a tuned receiving antenna. A radio receiver receives its input from an antenna and converts it into a form that is usable for the consumer, such as sound, pictures, digital data, measurement values, navigational positions, etc. Radio frequencies occupy the frequency range from 3 kHz to 300 GHz, although commercially important uses of radio use only a small part of this spectrum.

A radio communication system can send signals by radio. The radio equipment involved in communication systems includes a transmitter and a receiver, each having an antenna and appropriate terminal equipment such as a microphone at the transmitter and a speaker at the receiver, in the case of a voice-communication system. The equipment is often connected to a central headset/microphone. These systems generally contain Push-To-Talk (PTT) devices which allow the operator to select what component of the communication system to activate (or de-activate).

### SUMMARY

This application relates generally to communications systems containing a Push-To-Talk (PTT) device with an auxiliary audio component. The communication system can be worn by an operator and comprises a radio, a headset, a communication device (such as a cellular phone, mp3 player, audio recorder, etc.), and a Push-To-Talk (PTT) device modified with an auxiliary audio component capable of overriding or controlling communication between the headset and the communication device when a signal is transmitted to or received from the radio. The modified PTT device allows the operator of the system when wearing the headset to use the communication device (i.e., cellular phone) without the fear of interrupting communication with the radio. The operator can also connect to audio devices such as MP3 players and audio recorders.

### BRIEF DESCRIPTION OF THE DRAWINGS

The following description can be better understood in light of Figures herein which show various embodiments and configurations of the communication systems. Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated.

FIG. 1 illustrates some embodiments of a communication system that can be used by a mobile operator.

FIG. 2 illustrates some embodiments of a communication system containing a modified Push-To-Talk (PTT) device connected to a communication device.

FIG. 3 illustrates some embodiments of a communication system containing a modified Push-To-Talk (PTT) device connected to a communication device.

FIGS. 4-10 illustrate some embodiments of the PTT device modified to contain an auxiliary audio component.

FIG. 11 illustrates some embodiments of an auxiliary port that can be used in the modified PTT devices.

In addition, as the terms on, disposed on, attached to, connected to, or coupled to, etc. are used herein, one object (e.g., a material, element, structure, member, etc.) can be on, disposed on, attached to, connected to, or coupled to another object-regardless of whether the one object is directly on, attached, connected, or coupled to the other object or whether there are one or more intervening objects between the one object and the other object. Also, directions (e.g., on top of, below, above, top, bottom, side, up, down, under, over, upper, lower, lateral, orbital, horizontal, etc.), if provided, are relative and provided solely by way of example and for ease of illustration and discussion and not by way of limitation. Where reference is made to a list of elements (e.g., elements a, b, c), such reference is intended to include any one of the listed elements by itself, any combination of less than all of the listed elements, and/or a combination of all of the listed elements. Furthermore, as used herein, the terms a, an, and one may each be interchangeable with the terms at least one and one or more.

### DETAILED DESCRIPTION

The following description supplies specific details in order to provide a thorough understanding. Nevertheless, the skilled artisan will understand that the described devices can be implemented and used without employing these specific details. Indeed, the described devices and methods can be placed into practice by modifying the described systems and methods and can be used in conjunction with any other apparatus and techniques conventionally used in the industry.

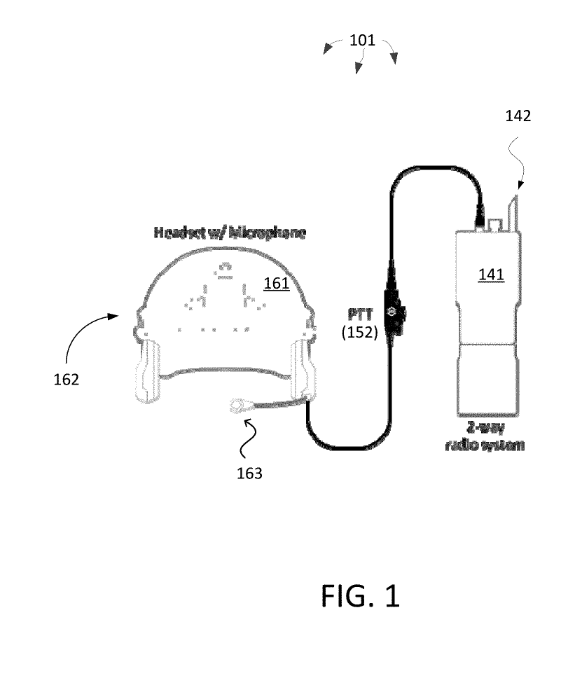

FIG. 1 illustrates an example of a communication system that can be used to perform various communication functions or procedures. The communication system includes operator communication equipment 101, as well as other communication equipment. This communication configuration can be portable or fixed, associated with a stationary operator or a mobile operator, and/or outfitted in a vehicle or in a command center.

As shown in FIG. 1, the operator communication equipment 101 includes one radio 141 and a push-to-talk (PTT) device 152 and headset 161 which includes speakers 162 and microphone 163. The radio 141 contains any type of device capable of transmitting radio signals and/or receiving radio signals using antenna 142. In some configurations, the communication system contains a two-way radio (transceiver) that allows the operator to have a conversation with other similar radios operating on the same radio frequency (channel). A transceiver typically combines and shares common transmitting and receiving circuitry in a single housing. Transceiver radios are available in mobile, stationary base, and hand-held portable configurations.

Radio 141 also electrically interfaces with headset 161. Received radio signals by radio 141 can be transformed to audible messages at speaker(s) 162. The operator's audible message into microphone 163 can be transformed to an electrical signal and transmitted via antenna 142 of radio 141.

In the embodiments illustrated in FIG. 1, the PTT device 152 typically includes a device capable of manually or remotely activating the transmit function on a transmitting radio when actuated. In some embodiments, a button can be actuated (i.e., depressed) to activate the transmit function. Two-way radio systems usually operate in a half-duplex mode; that is, the operator can talk, or he can listen, but not at the same time. A push-to-talk or press-to-transmit button activates the transmitter, when it is released the receiver is active.

In some embodiments, the PTT device 152 can provide an electrical connection between radio 141 and microphone 163. When the button on PTT device 152 is depressed, the transmit function of radio 141 is activated and the radio operates in a transmit mode. When the button on PTT device 152 is released, the radio 141 operates in a receive mode.

The headset 161 can include any type equipment capable of being worn or utilized by an operator to house speakers 162 and/or microphone 163. In some configurations, the headset combines a headphone with a microphone. Headsets can be made with either a single-earpiece (mono) or a double-earpiece (mono to both ears or stereo). Headsets can provide the equivalent functionality of a telephone handset but with hands-free operation. The microphone arm of the headset can carry an external microphone or be of the voicetube type. In some embodiments, a microphone 163 within headset 161 can be electrically connected to the radio 141 via PTT device 152. When a button on the PTT device 152 is pressed, the transmit mode on radio 141 is activated, and any audible communication into microphone 163 is transmitted via radio 141. When the button on PTT device 152 is released, the receiver on radio 141 is activated and any audible communication is received by the operator via radio 141.

The communication systems illustrated in FIG. 1, though, has a limited ability for a user to communicate with any other communication device that is not part of the communication system. For example, it would be helpful if the user could communicate with a cellular telephone (or other external communication device like a music player, microphone, speaker, and/or audio recorder) that is not part of the communication system. This need has been solved in the past by opening the existing communication system containing a PTT device shown in FIG. 1 and installing an after-market device that can be used to communicate with the cellular phone. This solution will unfortunately void the warranty for such a communication system, as well as potentially risk permanent damage to the communication system.

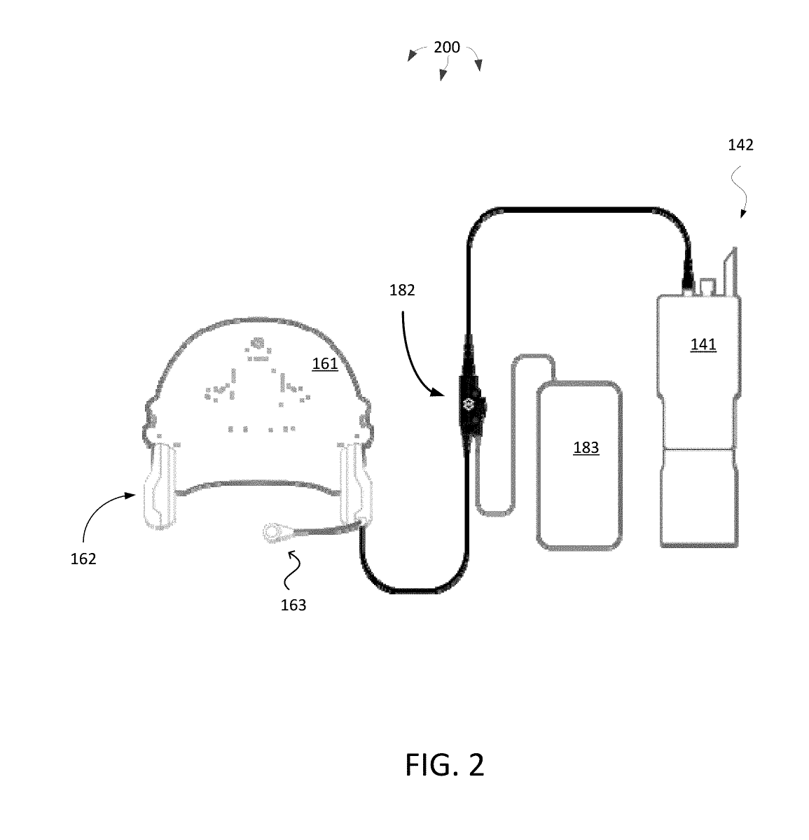

FIG. 2 illustrates communication systems 200 where the PTT device has been modified to contain an auxiliary audio component. In these configurations, the PTT device 182 allows for the incorporation of a communication device 183 into the communication system. Such a configuration allows the operator to communicate with external systems and external personnel using the communication device 183. Examples of the communication device 183 include cellular telephones, music players, microphones, speakers, audio recorders, and/or combinations thereof.

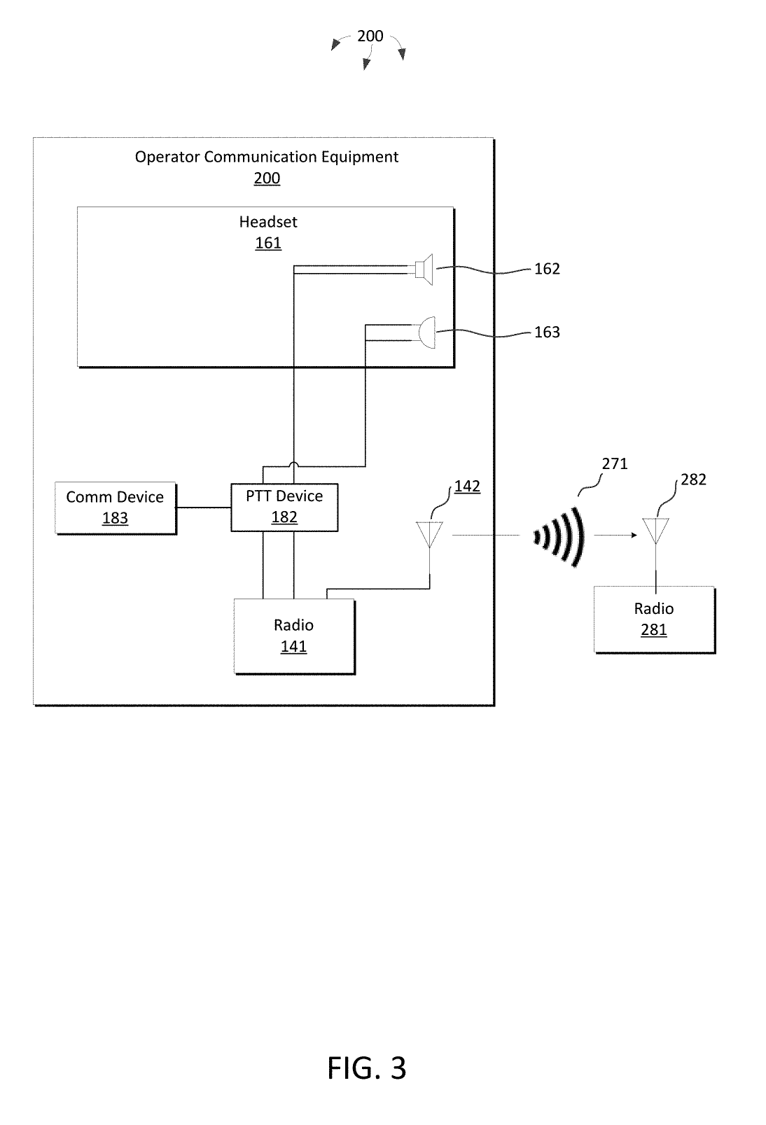

As shown in FIGS. 2 and 3, the communication system 200 includes communication equipment containing communication device 183, PTT device 182, radio 141, and headset 161. Radio 141 is configured to transmit radio signals and receive radio signals utilizing antenna 142. Radio 141 can interface with headset 161, and PTT device 182. Radio 141 can be mobile, stationary base, and/or hand-held portable radios, such as walkie-talkies, and the like. Radio 141 can transmit radio signals when in transmit mode and can receive radio signals when in receive mode.

As depicted, headset 161 includes speaker 162 and microphone 163. Headset 161 is configured to be worn by an operator to house speakers 162 and microphone 163. Headset 161 is configured to electrically interface with radio 141. For example, speakers 162 can be configured to convert radio signals received by radio 141 into audible signals that the operator can hear. Additionally, microphone 163 within headset 161 is configured to electrically interface with radio 141. Speaker 162 of headset 161 can be a single-earpiece design or a double-earpiece design, and the like. Microphone 163 of headset 161 can be an external microphone or of the voicetube type, and the like.

As depicted in FIG. 3, the communication system 200 can optionally include external radio 281. Radio 281 is configured to receive and transmit radio signals via antenna 282. For example, radio 281 can receive and/or transmit radio signals 271 from antenna 142 of radio 141.

As illustrated in FIGS. 2 and 3, the communication system 200 contains a modified PTT device 183. The PTT device 183 allows the operator to use both the communication device 183 and the radio 141. In some embodiments, the PTT device has been modified to include an auxiliary audio component comprising a 3.5 mm audio jack that can be connected to the communication device 183. The auxiliary audio component enables the operator to use the communication device 183 while radio communication from the radio 141 can be kept at a minimum. In some configurations, the communication system can be modified to contain two or more communication devices by incorporating additional audio components into the PTT device.

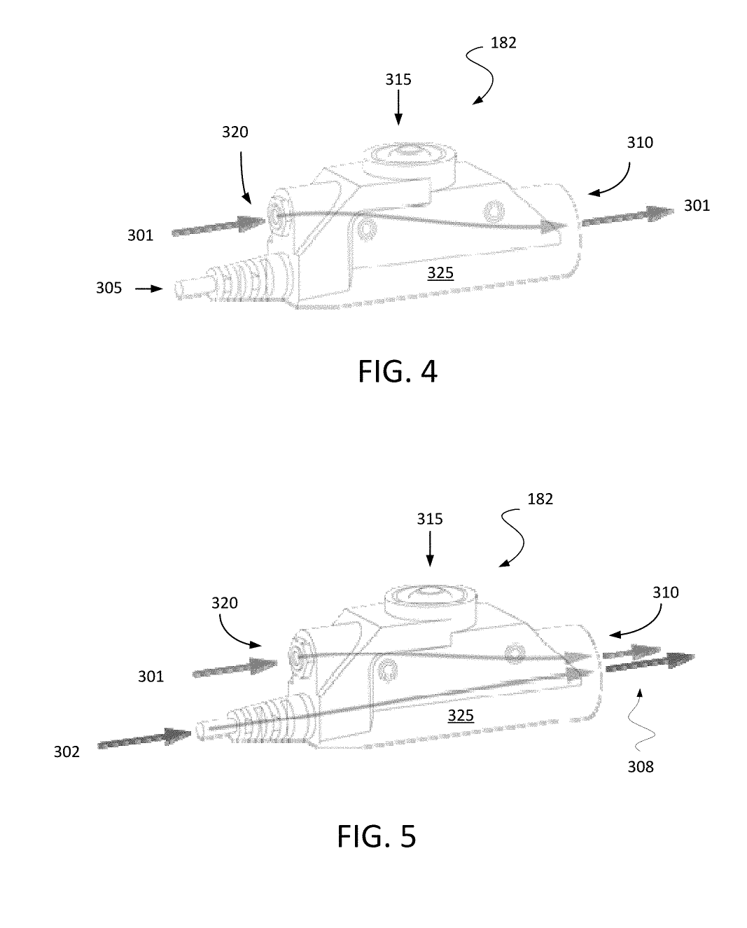

Some configurations of the PTT device 182 are illustrated in FIG. 4. As shown in FIG. 4, the PTT device 182 contains an input-output (I/O) device 310 for electrical connection with a headset, an I/O device 305 for electrical connection with the radio, an actuator 315, an auxiliary audio component 320, and housing 325. The PTT device 182 allows the auxiliary audio stream 301 from the communication device 183 to pass to the operator's headset.

Other configurations of the PTT device 182 are illustrated in FIG. 5. In these configurations, the PTT device 182 can be used so that when the radio 141 receives a transmission (i.e., from radio 281), the PTT device 182 that contains the auxiliary audio component can automatically overlay the auxiliary audio signal 301 from the communications device 183 and the radio's received audio signals 302. The PTT device 182 then passes the combined audio signals 308 to the operator's headset 161.

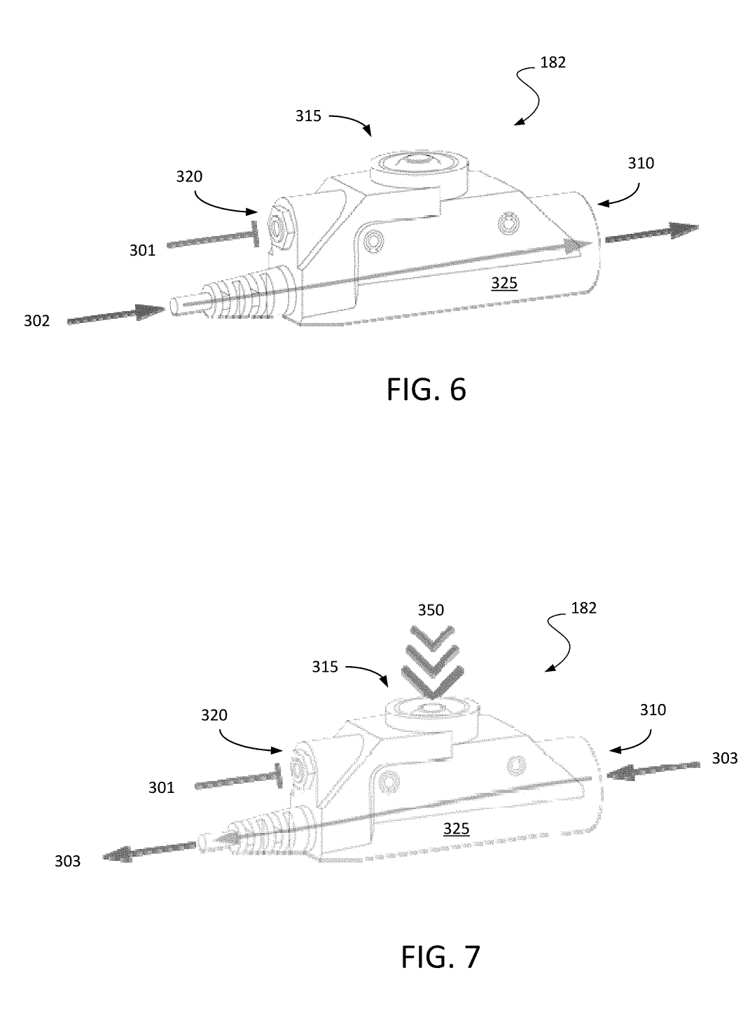

Other configurations of the PTT device 182 are illustrated in FIG. 6. In these configurations, the PTT device 182 can be used so that when the radio 141 receives a transmission (i.e., from radio 281), the PTT device 182 that contains the auxiliary audio component can automatically reduce or eliminate the auxiliary audio signal 301 from the communications device 183 and the radio's received audio signals 302.

Other configurations of the PTT device 182 are illustrated in FIG. 7. In these configurations, when the operator actuates 350 the PTT device 182 (i.e., by depressing actuator 315 such as a button) in order to transmit signals from the radio 141, the auxiliary audio signal 301 from the communication device 183 can be reduced or eliminated so that this audio signal is muted. The PTT device 182 then passes the operator's microphone audio signal 303 to the radio 141 for transmission.

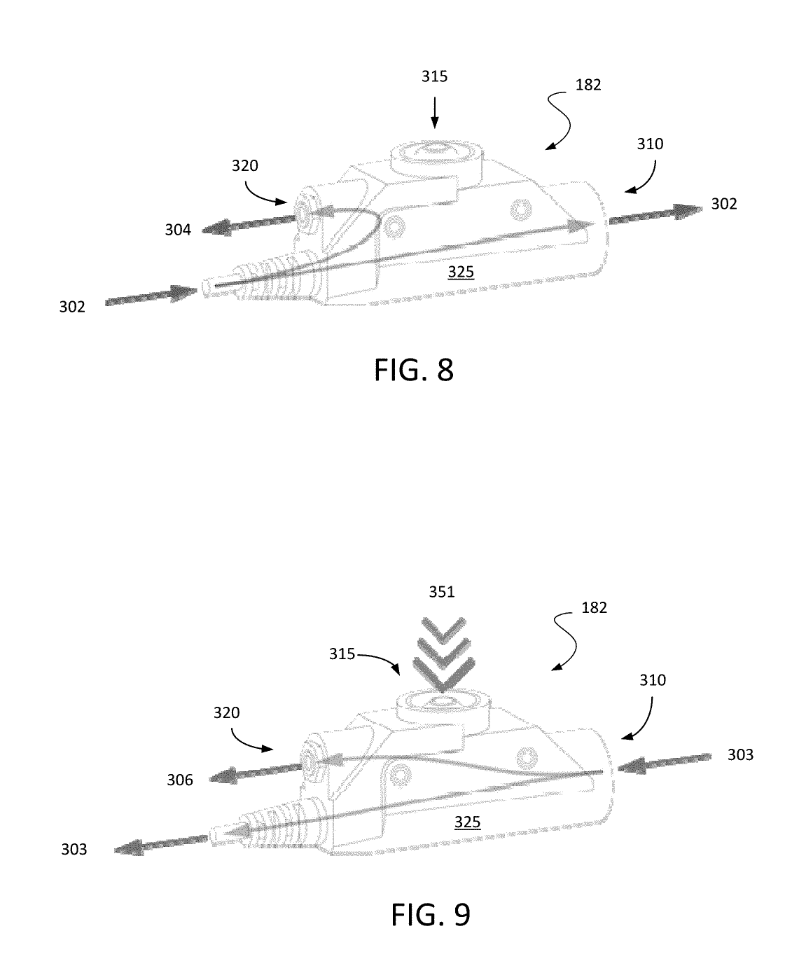

Yet other configurations of the PTT device 182 are illustrated in FIG. 8. The auxiliary audio component in the PTT device 182 can allow the operator to record both the received audio signal 302 from the radio 141 and/or the transmitted audio signal from the operator's microphone 163 by using the recording capability of the communication device 183. For example, when the radio 141 receives the audio signal 302 from the radio 141, the PTT device 182 passes the radio's received audio signal back though the auxiliary audio output to the headset as an audio signal 304 that can be recorded.

Yet other configurations of the PTT device 182 are illustrated in FIG. 9. When the operator activates 351 the PTT device 182 in order to transmit an audio signal 303 from the radio 141, the PTT device 182 passes the operator's microphone audio signal 303 to the radio and to the auxiliary audio output via audio signal 306.

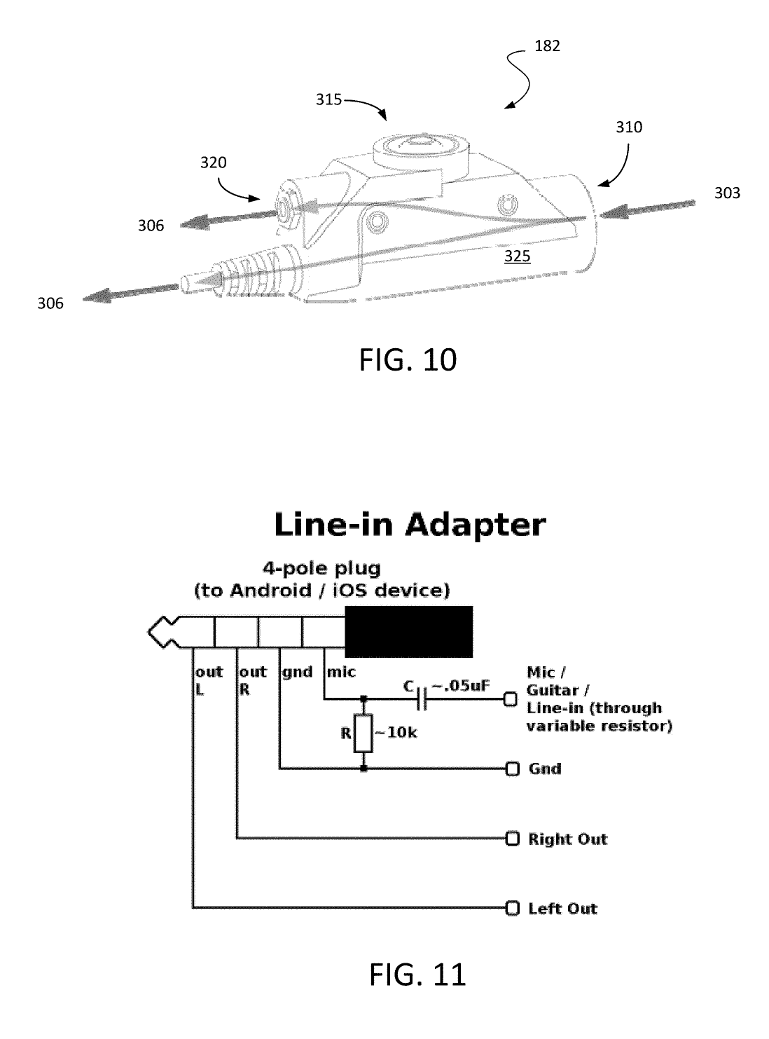

Yet other configurations of the PTT device 182 are illustrated in FIG. 10. The PTT device 182 passes the operator's microphone audio signal 303 to the radio and to the auxiliary audio output via audio signal 306 even when the actuator is not depressed. This operation allows the operator to use “hands free mode” on a cellular phone without transmitting the microphone audio signal to other radios.

The auxiliary audio component in the PTT device 182 therefore operates as a control mechanism during communication by the operator. In some instances, auxiliary audio component blocks communication with the communication device 183 when a communication signal needs to be received from—or delivered to—the radio by the headset. In other instances, the auxiliary audio component permits communication with the communication device 183 when a communication signal does not need to be received from—or delivered to—the radio by the headset.

In some configurations, this control (or override function) can be accomplished using the auxiliary port described herein and shown in the Figures. The auxiliary (or AUX) port comprises a standard 3.5 mm TRRS (Tip, Ring, Ring, Sleeve) audio-style receptacle. The AUX port contains left and right speaker channels and a microphone channel, all three of which are analog audio signals. The majority of existing devices support the Cellular Telephone Industries Association (CTIA) style arrangement, as shown in FIG. 11. Of course, the auxiliary port can be modified for other types of communication devices.

Using the PTT device modified with the auxiliary audio component provides several helpful features. The first feature is the ability is to introduce background distractions in the form of MP3 files played in conjunction with radio transmissions to aid in the training of operators. Second, the auxiliary audio component can be used to boost morale enabling the operator to listen to music while simultaneously monitoring the radio. This is done responsibly through the components that allow the radio communications to take priority over the auxiliary audio. The final helpful feature is the ability to attach the modified PTT device to a communication system capable of recording audio for both training and real world tactical scenarios. This will aid the operator in collecting and disseminating accurate, truthful data very much needed for an effective debrief or investigation into events. These features can be obtained without using an after-market device since all of the needed circuitry is integrated into the modified PTT device.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A communication system, comprising:
a radio;
a communication device transmitting an audio signal;
a headset containing a microphone and a speaker and configured to interface with the radio; and
a Push-To-Talk (PTT) device containing integrated circuitry and configured to interface with the headset, the radio, and the communication device so the PTT device permits audio signals to be transmitted to or from the headset, to or from the radio, and to or from communication device.

2. The system of claim 1, wherein the communication device is a music player, microphone, speaker, audio recorder, or cellular phone.

3. The system of claim 1, wherein the PTT device permits audio signals to be transmitted from the communication device to the headset while eliminating or reducing audio signals from the radio.

4. The system of claim 1, wherein the PTT device permits audio signals to be transmitted both from the communication device and from the radio to the headset.

5. The system of claim 1, wherein the PTT device permits audio signals to be transmitted from the radio to the headset while eliminating or reducing audio signals from the communication device.

6. The system of claim 1, wherein the PTT device permits audio signals to be transmitted to the communication device from the headset while eliminating or reducing audio signals to the radio.

7. The system of claim 1, wherein the PTT device permits audio signals to be transmitted both to the communication device and to the radio from the headset.

8. The system of claim 1, wherein the PTT device permits audio signals to be transmitted to the radio from the headset while eliminating or reducing audio signals to the communication device.

9. A Push-To-Talk (PTT) device, comprising:
an input-output (I/O) device for electrical connection with a headset containing a microphone and a speaker; and
an I/O device for electrical connection with a radio;
an auxiliary audio component for electrical connection to a communication device; and
an actuator connected to integrated circuitry configured to permit audio signals to be transmitted to or from the headset, to or from the radio, and to or from communication device.

10. The device of claim 9, wherein the PTT device permits audio signals to be transmitted from the communication device to the headset while eliminating or reducing audio signals from the radio.

11. The device of claim 9, wherein the PTT device permits audio signals to be transmitted both from the communication device and from the radio to the headset.

12. The device of claim 9, wherein the PTT device permits audio signals to be transmitted from the radio to the headset while eliminating or reducing audio signals from the communication device.

13. The device of claim 9, wherein the PTT device permits audio signals to be transmitted to the communication device from the headset while eliminating or reducing audio signals to the radio.

14. The device of claim 9, wherein the PTT device permits audio signals to be transmitted both to the communication device and to the radio from the headset.

15. The device of claim 9, wherein the PTT device permits audio signals to be transmitted to the radio from the headset while eliminating or reducing audio signals to the communication device.

16. A communication method, comprising:
providing communication system containing a radio, a communication device transmitting an audio signal, a headset containing a microphone and a speaker and configured to interface with the radio, and a Push-To-Talk (PTT) device containing integrated circuitry and configured to interface with the headset, the radio, and the communication device;
activating the PTT device to permit audio signals to be transmitted to or from the headset, to or from the radio, and to or from communication device.

17. The method of claim 16, wherein the PTT device permits audio signals to be transmitted to or from the communication device while eliminating or reducing audio signals to or from the radio.

18. The method of claim 16, wherein the PTT device permits audio signals to be transmitted both to and from the communication device and to and from the radio.

19. The method of claim 16, wherein the PTT device permits audio signals to be transmitted to and from the radio while eliminating or reducing audio signals to or from the communication device.
